(19) United States
(12) Patent Application Publication
(10) Pub. No.: US 2022/0398569 A1
(43) Pub. Date: Dec. 15, 2022

(54) LEARNING RECOMMENDATION ENGINE FOR FAMILY CHORE MANAGEMENT SYSTEM

(71) Applicant: Rotation 5, Inc., Los Altos, CA (US)

(72) Inventors: Sen Reeves Xavier, Los Altos, CA (US); Priyadarshini Rajendran, Los Altos, CA (US)

(21) Appl. No.: 17/835,309

(22) Filed: Jun. 8, 2022

Related U.S. Application Data
(60) Provisional application No. 63/208,533, filed on Jun. 9, 2021.

(51) Int. Cl. G06Q 20/36; G06Q 20/06

(52) U.S. Cl. CPC G06Q 20/3678; G06Q 20/065

(57) ABSTRACT

A server for recommending tasks for completion includes a memory including a database configured to store information associated with a plurality of users, and an application coupled to a processor. The server stores a set of chores associated with a plurality of existing users. Each chore is matched with an existing user characteristic. The server receives a first request by a first user for registering with the application. The first request includes a first user characteristic. The server recommends a first chore assignment for the first user based on the first user characteristic. The first chore assignment is based on a comparison of the first user characteristic against a plurality of existing user characteristics. The server further sends a signal to an electronic device for displaying the first chore assignment.

### CROSS REFERNECE TO RELATED APPLICATIONS

This application claims priority to U.S. Provisional Patent Application No. 63/208,533 filed on Jun. 9, 2021, by Sen Reeves Xavier and Priyadarshini Rajendran, entitled “LEARNING RECOMMENDATION ENGINE FOR FAMILY CHORE MANAGEMENT SYSTEM,” the entire content of which is incorporated by reference herein.

### TECHNICAL FIELD

Embodiments described herein relate generally to systems and methods for creating and using personalized digital tokens convertible to regular currency for online money-management for use by families and communities operating in a closed environment.

### BACKGROUND

Parents aspire to have their children learn to complete household and other assigned activities and further for their children to grow into financially responsible adults. Parents give allowances to children, and these allowances are often tied to completion of certain household activities such as chores. Children learning to complete chores with minimal prodding from parents can help the children grow into responsible, self-managed and independent adults. Children learning to manage allowance money received from their parents in a responsible manner can help the children gain valuable financial management skills. Parents have a vested interest in ensuring that the allowance money that they give to their children is not spent on undesirable items. However, conventional methods of managing how children spend their allowance money do not provide parents with sufficient tools for adequately supervising and controlling how the allowance money is being spent.

With widespread use of mobile computing devices by children, it would be desirable to have a system and method which allows parents adequate control and supervision over how allowance money is spent by their children in a computer-based environment. It would further be ideal for the system to be set up such that parents have to expend minimal time in setting up the system as well as in using the system on an ongoing basis.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclosed herein is a server for recommending tasks for completion for a user of an electronic device. In various embodiments, the server comprises a memory including a database configured to store information associated with a plurality of users, and an application coupled to a processor. The application stores a set of chores associated with a plurality of existing users, wherein each chore of the set of chores is matched with an existing user characteristic. The application receives a first request by a first user for registering with the application, the first request including a first user characteristic. The application recommends a first chore assignment for the first user based on the first user characteristic, wherein the first chore assignment is based on a comparison of the first user characteristic against a plurality of existing user characteristics. The application sends a signal to an electronic device associated with the first user for displaying the first chore assignment.

Disclosed herein is a server for recommending tasks for completion for a user of an electronic device. In various embodiments, the server comprises: a memory including a database configured to store information associated with a plurality of users; and an application coupled to a processor. The application is configured to: store a set of chores associated with a plurality of existing users in a plurality of network-based non-transitory storage devices, wherein each chore of the set of chores is assigned an existing user attribute score based on an existing user characteristic; receive a first request by a first user in real time made through a graphical user interface over a network for registering with the application, the first request including a first user characteristic; calculate a first user attribute score for the first request based on the first user characteristic; compare the first user attribute score against a plurality of existing user attribute scores to identify a first chore from the set of chores such that an existing user attribute of the first chore correlates to the first user attribute score; automatically generating a message containing the first chore send a signal in real time to an electronic device associated with the first user for display on the graphical user interface so that that the first user has immediate access to the first chore.

### BRIEF DESCRIPTION OF THE DRAWINGS

FIG. 1 is a schematic block diagram of a digital payment management and tracking system, according one or more embodiments of the presently disclosed subject matter.

FIG. 2 is a flow chart of various aspects of a digital payment management and tracking system, according one or more embodiments of the presently disclosed subject matter.

FIG. 3 is a flow chart of various aspects of a digital payment management and tracking system, according one or more embodiments of the presently disclosed subject matter.

FIG. 4 is a schematic representation of a chore artificial intelligence (AI) module forming part of the digital payment management and tracking system, according one or more embodiments of the presently disclosed subject matter.

FIG. 5 is an illustration of an exemplary software-as-a-service (SaaS) model for implementing a digital payment management and tracking system, according one or more embodiments of the presently disclosed subject matter.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. References to “one embodiment” or “an embodiment” in the present disclosure may be (but are not necessarily) references to the same embodiment, and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

Alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the presently disclosed subject matter relate to a system and method that includes a learning recommendation engine that can advantageously provide for easy setup of a chore management system such as the one described in International Patent Application No. PCT/US2019/064101, the entire contents of which are incorporated herein by references. It generally takes a substantial amount of time to setup a family chore management system, and it takes a lot of effort to keep it running effectively. A learning recommendation engine forming part of the system as disclosed herein can advantageously provide for easy setup of a chore management system and, and further provide for ease of maintenance of the chore management system after its installation on a computing device such as a mobile device. The recommendation engine may use artificial intelligence (AI), machine learning, natural language processing and internet of things (IoT) techniques to set up an intelligent family chore management system that combines crowd-sourced information from a plurality of users on the chore management platform as well as other chore-related databases with minimal information needed to be provided by a new user of the chore management system, for example, about the new user's family The system can accordingly supply to a new user of the system with a recommended list of chores that is customized for the needs of the new user. In one embodiment, the user may set up the chore management system for use by a social unit such as a family, for example. The term “family” as used herein is a group of one or more parents and their children living together as a unit. A family set within the chore management system can typically include activities and tasks (commonly referred to herein as “chores”) for various individual members (e.g., children within the family unit) that are expected to be completed by them by due time following a schedule.

The chore management system (alternately referred to herein simply as “system”) includes a learning recommendation engine (alternately referred to herein simply as “engine”) may only require minimal information from a new user such as, for example, the age of each kid in the family The system may combine this minimal information with ephemeral data to create a set of chore recommendations for the family The system may further recommend schedules for each recommended chore, assigns points. The system may further configure and/or adjust the chores as well as the chore schedules to improve their effectiveness. The system may further apply various gamification techniques (for e.g., streaks and badges) for improving engagement of the family members. The system may further process and understand behavior patterns of family members based on their respective interactions with the system and may customize prompts and nudges based on each family member's behavior patterns with the goal of completion of all assigned activities in an efficient manner The system may further generate a daily summary as well as periodical reports to assists parents with managing the chore system set up better.

The system directly addresses the fact that most parents are tight on time. In a recent survey of more than 700 parents, it was found that the number one reason families do not have a chore management system in place is because they just don't have the time to set one up. Parents are desperately turning to project management tools available in the workplace such as Asana, Trello or Jira to manage household chores. However, project management principles customized for workplace applications are not necessarily suitable for household chore management. Using robust technology, the system can help parents actually manage the chaos of maintaining a home without taking up time that we know they don't have.

In various embodiments, the system allows parents to set up and customize their family profile. Within the application forming part of the system wherein the application operates on a computing device such as a mobile phone, parents fill out information on the number of household members, their ages and any pets. The system then automatically creates, schedules and assigns chores and rewards. In at least one embodiment, the system may pulling data and insights from more than 130,000 families that use the chore system. The system may proceed to quickly identify and assign appropriate chores and reward points for each family member based on age and a given household's anticipated needs. The application forming part of the system may intuitively schedule various chores on a daily, weekly or ongoing basis, such as, for example, clearing out the dishwasher every night or watering the houseplants once a week. The system may further automatically rotate responsibility among family members. By using the system as described herein, parents save an average of 8 hours per week associated with time spent managing chore assignments, reminders and rewards. Once a chore list is created within the system, the system may provide parents and caretakers with the ability to add and remove chores, adjust the time or cadence at which the chores need to be completed, and further adjust reward type or magnitude. As additional and new parents engage with the application and customize chore and reward characteristics, a learning engine forming part of the system may continue to learn and the system may such learning to further refine its future recommendations. The system may accordingly provide for an easy-to-use seamless chore management experience for parents whereby the parents can spend less time trying to manage the household and more time enjoying precious family moments. In at least one embodiment, the system may be electronically integrated with smart appliances to thereby allow parents to connect chore assignments with smart home appliances for even simpler household management.

According to various embodiments, chores can be assigned based on the skill, dexterity and/or age of the members of the family unit. It is to be noted that some chores that can be performed by adults may not be suitable for young kids. Also, a particular chore that applies to a family which lives in an apartment may not apply to a family that lives on a ranch. Such variations in the scope of chores can result in the user of the chore management system having to spend an inordinate amount of time in setting up a chore management system. Further, a chore management system once set up by a family may need frequent modifications as a family's chore dynamic may not be static, particularly when the kids are very young. For example, a chore list for a 6-year-old kid may become obsolete in six months the child grows since a chore considered vital at 6-years old may be considered optional at 6½ years of age.

In various embodiments, all data points acquired by the system, including changes to chores, behavior, and similar other data points, in addition to other related data points including weather, climatic changes, natural or man-made disasters, etc. are fed back into the engine to improve the intelligence of the system and change the recommendations. The system may further motivate and gather intelligence of the users of the system by using gamification techniques like streaks and badges. The information from such gamification techniques may be fed to the engine for the engine to in turn recommend modifications or suggestions to the learning system.

The system further provides for the generation of intelligent data reporting comparing the behavior of a family unit to a cohort of similarly situated families In some embodiments, the interactions captured by the system as well as the details found in these reports may be used to improve the intelligence of the learning system.

In some embodiments, the engine may generate an association with other families registered within the system to provide an intelligent recommendation to a new user (e.g., a new family unit) registering with the system and/or for a new family looking to add new or additional chores. For example, an invitation from a family already registered with the system to a new user use the service along with a relationship status can be used to recommend a similar set of chores. Or a family unit can be found to be associated with a template family unit and, as a result, will be recommended the same chores used by the template family

In at least one embodiment, when a chore is completed, the system notifies the user that originally set up the chore of the chore's completion. Similarly, the system may further notify if a chore is missed. The system may further generate a notification when a chore gets excused. A user such as system administrator may be able to interact with the learning system via an API (application Programing Interface) of a client that can be in the form of a mobile application, a website, or any other suitable service.

In various embodiments, the system is configured to provide a suggested list of chores to a new user as well as an existing user. The system is further configured to automatic scheduling of chores for any user, with the user having the ability to modifying the duration, frequency and other characteristics of the automatically scheduled chores. The system is further configured to adjust various characteristics of each chore suggested by the suggested for the age of the person who will be performing the chore at issue. As an illustrative example, the system may assign both morning and evening chores for brushing teeth for a 5-year-old but assign only an evening chore for a 7-year-old since the 7-year may have already formed the habit of brushing teeth in the morning. Further, for the 5-year-old, the system may require uploading of a picture that provides proof of the chore of bushing teeth having been completed, for example in the form of a wet toothbrush with time stamp. In one embodiment, the system is automatically able to verify the veracity of the picture, for example, by eliminating access to upload existing pictures and otherwise requiring a brand-new capture of the image through the application operating on a mobile device such as a mobile phone or tablet. After the picture is uploaded, a prompt may be sent to the parent of the child or kid to approve completion of the truth brushing task before reward points can be moved to the child's account.

In various embodiments, the system learns when a user, such as a patent, adjusts a recommended chore configuration. The system may record any such tweaks made to the recommended chore configuration and may further return such the data back to the chore logic. The system may further use such data points to further fine tune future recommendations. The system may further customize or otherwise normalize date for the local internet protocol (IP) assignment area, zip code, town, city, county, state, topography, elevation, and weather conditions, as applicable. In one example, if the kid's local area is in rural Kansas, the system will not require a picture verification of completion of brushing teeth when the system already has learned from prior data that lying that a chore has been completed (when it has not been actually completed) is very uncommon in that local area. The system may further include customized reminders that may include reminders before, during, and after a time interval scheduled for a chore. The system may further learn how many times, how often, at what intervals reminders had to be sent to a kid of a particular age group, particular sex, particular local area, particular day of the week, and similar other characteristics before chore actually got completed. In various embodiments, the system may push weekly, monthly or other periodic chore recommendations out to a parent user. The system may further recommend a reward points, for e.g., in the form of digital coins such as s'mores (i.e., the term “s'mores” is a name assigned to the digital coins in at least one embodiment whereby children may better relate to the accumulation of digital coins). For example, the system may recommend a reward of 50 s'mores for completion of the chore of making bed each morning for a child above the age of 10. The system may further recommend a reward of 100 s'mores for completion of the chore of making bed each morning for a child under the age of 10 since forming the habit of making one's bed is important for this age range. The system may further recommend a higher reward value till a habit is formed (e.g., first 3 months), followed by a lower reward value after it determines that a habit has been formed based on the completion statistics available to the system. The system may further reallocate the difference in reward value to another new chore in order to form a child's habit in that new chore. The system may further throttle the reward points up or down depending on compliance and completion data.

In at least one embodiment, the system may further be configured to integrate with a cloud based digital home management environment or a virtual assistant AI technology such as, for example, Amazon's Alexa, Google's Home, Microsoft's Cortana, Apple's Siri, and similar other environments and applications. The application associated with the system as described herein can be added as a skillset in one or more of such ecosystems and downloaded onto the cloud based digital home management environment whereby the system can integrates with, and operate seamlessly within, such ecosystems. Accordingly, in one embodiment, the parent can query the virtual assistant AI technology regarding the status of chore completion, wherein the virtual assistant AI technology may respond to the query by providing a status update including details around non-compliance items. The system may according be seamlessly integrated with the virtual assistant AI technology wherein the virtual assistant AI technology receives data and other information captured at a digital user interface of a mobile device such as a mobile phone.

In at least some embodiments, the system is configured for use by children and adults in the autistic spectrum. For some of such individuals, how some chores are stated (e.g., word consistency) may be very important. The system may include chore read out abilities that provide such needed consistency. For some others, certain things occurring at precise times may be vital, and may get stressed out if that does not occur. As a further example, people with executive dysfunction and/or ADHD commonly lack the ability to handle frustration, start and finish tasks, recall and follow multi-step directions, stay on track, self-monitor, and balance tasks (like sports and academic demands). Remediating the area of deficit reduces academic or work difficulties. The system as described herein can help children and adults with various conditions such as ADHD, autism and similar other conditions can be guided and helped through the system as described herein. Once the chores have been selected and set up within the system , the user (e.g., parent or caretaker) can “fill it, shut it, and forget it”, as the system will operate automatically in a self-guided manner without further directions or interactions required from the user. In other words, once the user provides preliminary information regarding the subjects or participants (e.g., age, sex, locality, unique conditions such as, for example, ADHD, autistic, geriatric or other special condition), the system provides a list of chores curated for each subject. When the user accepts the recommended chore configuration after making any tweaks as needed, the user can forget about having to remember various chores or activities associated with the subject as the system will manage, monitor and report on progress, and even fine tune the chore parameters in order to optimize the chore compliance in an effective manner The engine forming part of the system uses machine learning techniques to fine tune the effectiveness of chore management.

The system accordingly uses AI and machine learning techniques to free up much-needed time for parents, caregivers, and other project administrators. The system may represent a household management system that integrates with Amazon Alexa and Google home devices, making use of technology that is already available in many homes. With a simple, “Alexa, ask S'moresUp for the status?” parents can get quick, hands-free updates on all chore statuses without interrupting their current focus.

The system may operate to tackle modern-day parenting challenges while helping prepare kids for the real world. This system is highly customizable. The system includes a household management application that is configured for operating on a computing device such as a mobile computing device. Powered by AI and machine learning, S'moresUp now creates, schedules, reminds and assigns the right chores based on age and household needs in less than three minutes (an average 90 percent decrease), giving back valuable time for parents.

In various embodiments, based on the data set that is available, the system fine tunes family management for individual user/families and makes recommendation that will help them manage their families better that suits their personal preference, behavior and needs. The system may be accessed via an application operating on a computing device, through a web interface, and through APIs and smart assistants.

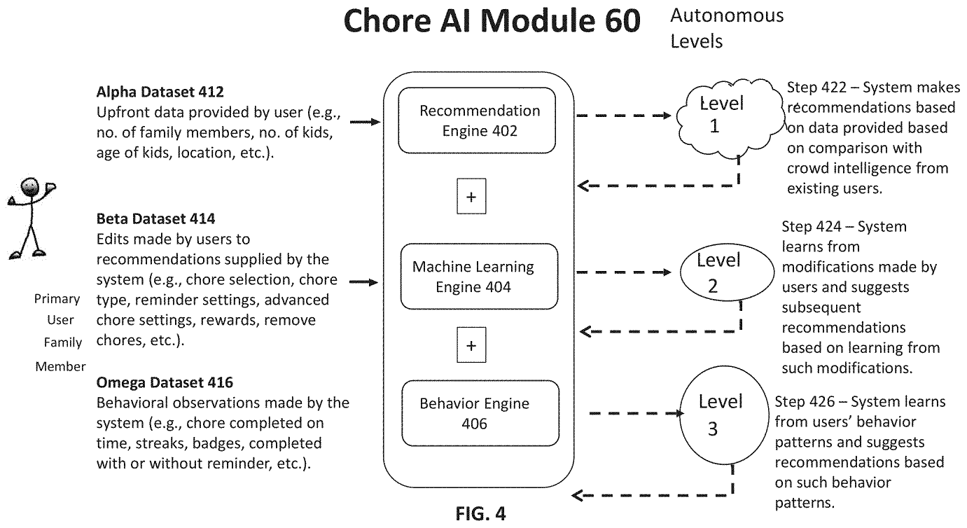

FIG. 4 illustrates one implementation of the chore management system. As illustrated in FIG. 4, chore AI module 60 forming part of system 100 can include recommendation engine 402, machine learning engine 404 and behavior engine 406. Each of recommendation engine 402, machine learning engine 404 and behavior engine 406 may use machine learning techniques, natural language processing, and artificial intelligence techniques in performing their respective tasks.

Alpha dataset 412 may include upfront data provided by user (e.g., no. of family members, no. of kids, age of kids, location, etc.). Recommendation engine 402 may use data available at alpha dataset 412 to make recommendations at step 422. At step 412, recommendation engine 402 of chore AI module 60 operates to make recommendations based on data provided based on comparison with crowd intelligence from existing users.

Beta dataset 414 may include edits made by users to recommendations supplied by the system (e.g., chore selection, chore type, reminder settings, advanced chore settings, rewards, remove chores, etc.). Machine learning engine 404 may use data available at beta dataset 414 at step 424. At step 424, machine learning engine 404 of chore AI module 60 operates to learn from modifications made by users and suggests subsequent recommendations based on learning from such modifications.

Omega dataset 416 may include data points associated with behavioral observations made by the system (e.g., chore completed on time, streaks, badges, completed with or without reminder, etc.). Behavior engine 406 may use data available at omega dataset 416 at step 426. At step 426, behavior engine 406 of chore AI module 60 operates to learn from users' behavior patterns and suggests recommendations based on such behavior patterns.

According to various embodiments, disclosed herein is a chore management and tracking server such as server 10 for recommending tasks for completion for a user of an electronic device. In various embodiments, server 10 includes a memory including a database 12 configured to store information associated with a plurality of users. Server 10 further includes an application coupled to a processor. The application configured to store a set of chores associated with a plurality of existing users, for example, at database 12. Each chore of the set of chores is matched with an existing user characteristic. For example, the set of chores may be saved in a table format wherein each chore is assigned a one or more user characteristics. In one embodiment, the user characteristics may be accrued by the server base on existing users. In other words, user characteristics may those associated with users already signed up for service with server 10. In one embodiment, server 10 receives a first request by a first user via parent mobile application 74 for registering with the application operating on the server. In one embodiment, the first user is a parent. The first request may include various pieces of information including a number of family members associated with the first user; an age of a family member associated with the first user; a number of children associated with the first user that are under 18 years of age; and a location associated with the first user (commonly referred to as “first user characteristic”).

Server 10 may further recommend a first chore assignment for the first user based on the first user characteristic. In various embodiments, the recommendation of the first chore assignment is based on a comparison of the first user characteristic against a plurality of existing user characteristics. Server 10 may further send a signal via network 20 to an electronic device associated with the first user for displaying the first chore assignment. In one embodiment, the electronic device associated with the first user may be a parent mobile device 70. In various embodiments, server 10 is further configured to capture at least one of: a customization attribute made by the first user to the first chore assignment, and a behavior attribute associated with completion of the first chore assignment. The customization attribute comprises an adjustment made by the user to one or more of following suggestions supplied by the server: a chore reminder frequency; a chore repetition frequency; a chore reward magnitude; a chore characteristic adjustment. The behavior attribute comprises a one or more of: a time take for completion of the first chore; number of reminders generated for the first chore; a time interval taken beyond a deadline generated by the server for completion of the first chore. The server may further store the customization attribute to the database or in one of a plurality of network-based non-transitory storage devices. Similarly, the server may further store the behavior attribute to the database or in one of a plurality of network-based non-transitory storage devices.

Disclosed herein is a server for recommending tasks for completion for a user of an electronic device. In various embodiments, the server comprises: a memory including a database configured to store information associated with a plurality of users; and an application coupled to a processor. The application is configured to: store a set of chores associated with a plurality of existing users in a plurality of network-based non-transitory storage devices, wherein each chore of the set of chores is assigned an existing user attribute score based on an existing user characteristic; receive a first request by a first user in real time made through a graphical user interface over a network for registering with the application, the first request including a first user characteristic; calculate a first user attribute score for the first request based on the first user characteristic; compare the first user attribute score against a plurality of existing user attribute scores to identify a first chore from the set of chores such that an existing user attribute of the first chore correlates to the first user attribute score; automatically generating a message containing the first chore send a signal in real time to an electronic device associated with the first user for display on the graphical user interface so that that the first user has immediate access to the first chore.

In one example, the server may assign an existing user attribute score of 45 based on an existing user characteristic, The server may calculate a first user attribute score of 42 for the first request based on the first user characteristic. The server compares the first user attribute score 42 against a plurality of existing user attribute scores that may range from 0 to 100 in one embodiment, for example, to identify a first chore of emptying the dishwasher from the set of chores such that an existing user attribute score of the first chore 45 correlates to the first user attribute score of 42. In one embodiment, an algorithm forming part of the system may pick a first chore whose existing user attribute score is within +/−5 points of the first user attribute score. In one embodiment, an algorithm forming part of the system may pick a first chore whose existing user attribute score is within +/−1 point of the first user attribute score. In one embodiment, an algorithm forming part of the system may pick a first chore whose existing user attribute score is within +/−25 points of the first user attribute score.

In some embodiments, the server is further configured to receive a second request by a second user for registering with the application, wherein the server assigns a second chore for the second user based on a second user characteristics. In some embodiments, the server is further configured to modify the first chore assignment by at least one of the customization attribute and the behavior attribute to arrive at the second chore. In some embodiments, the server is further configured to append the second chore to the plurality of chores. In some embodiments, the server is further configured to store the customization attribute as a further user characteristic associated with the first chore. In some embodiments, the server is further configured to store the behavior attribute as a further user characteristic associated with the first chore. In some embodiments, the server is further configured to capture a rejection of a first chore assignment by the first user.

In some embodiments, the server is further configured to receive a second request by a second user for registering with the application, wherein the server assigns a second chore for the second user based on a second user characteristics, wherein the second chore is unrelated to the first chore. In some embodiments, the first user characteristics comprises demographic information on family members associated with the user. In some embodiments, the server is further configured to generate a ranked predicted list of chores for each request, the ranked predicted list of chores comprising at least some chores selected from a set of potentially recommendable chores, such that each particular chore within the ranked predicted list of chores has an associated rank. In some embodiments, the server is further configured to assign a plurality of chores for the first user, wherein the plurality of chores is ranked based on the user characteristic. In some embodiments, the server is further configured to receive notification from a family member associated with the first user that the assigned chore has been completed; and transfer digital coins equal to a digital coin value of the chore assignment from a first digital wallet associated with the first user to a second digital wallet associated with the family member. In some embodiments, the server is further configured to record the transfer of the digital coins in a digital coin ledger. In some embodiments, the server is further configured to apply the one or more digital coins in the second digital wallet to acquire one or more of a plurality of purchase items.

The subject matter described herein accordingly provides new systems and methods which allow parents to supervise, manage and control how chores are completed by their children in a computer-based environment. Also disclosed herein are new systems and methods which allow project organizers, project leaders, and caregivers of individuals with autism or other special conditions to supervise chores performed by such individuals. The system may further provide a computer-based environment to community-based projects such as church projects, school projects, neighborhood projects, grass-root projects, and not-for-profit projects, among others. The system may further be used to allow educators to supervise and control students learning in a computer-based environment as it applies to education-related projects.

In some embodiments, the system may also provide efficient digital tracking and payment systems and methods for agreements between parents/guardians and the children/minors under their guidance or custody. The system further allows for children/minors and parents/guardians to enter into agreements for services such as household chores, for example, and other actions in exchange for rewards through a single portal digital application configured for tracking the services assigned to children/minors and notifying the appropriate party of completion thereof. The system provides a mechanism for funding and transfer of payments between individuals digitally using mobile devices such as smart phones and computers over a network such as the internet.

The financial transactions can include transfer from an account associated with a parent (“parent accounts” or “first digital wallet associated with a first user”) at a financial institution to an account associated with a corresponding child (“child accounts” or “second digital wallet associated with a second user”) at the same or a different financial institution, with both the first and second digital wallets in digital communication with the system. Alternately, both the first and second digital wallets can form part of, or reside within, the system.

The system further advantageously allows for the creation, distribution, and exchange of digital coins convertible to a local currency such as, for example, the US dollar and vice versa, whereby allowances are given in the form of digital coins. The digital coins can advantageously permit a parent/guardian to supervise and control how the digital coins are spent by the child/minor. This can ensure that the allowance money is not spent in pursuits contrary to the goals and objectives that a parent/guardian may have with regard to the allowance given to the child/minor.

The system will now be described with respect to chores and/or household activities performed in a family setting. However, this system may be applied to several other settings. For example, the system may be beneficially utilized in church projects, school projects, neighborhood projects, school projects, learning environments, grass-root projects, and not-for-profit projects, among others, with limited funding may benefit from a system and method that allows a project organizer to manage how the limited funding is spent meaningfully in a computer-based environment. The customized or customizable digital coin availability made possible by the system can advantageously allow for rewarding task completions within a closed environment.

The system can further provide customized or customizable internal digital coins for its users. These digital coins can be converted into cash value and vice versa. In at least one embodiment, the customized digital coin may be referred to as “s'mores”. In some embodiments, the digital coins can be exchanged for tokens, hierarchal certificates, hierarchal accolades, hierarchal citations, and combinations thereof.

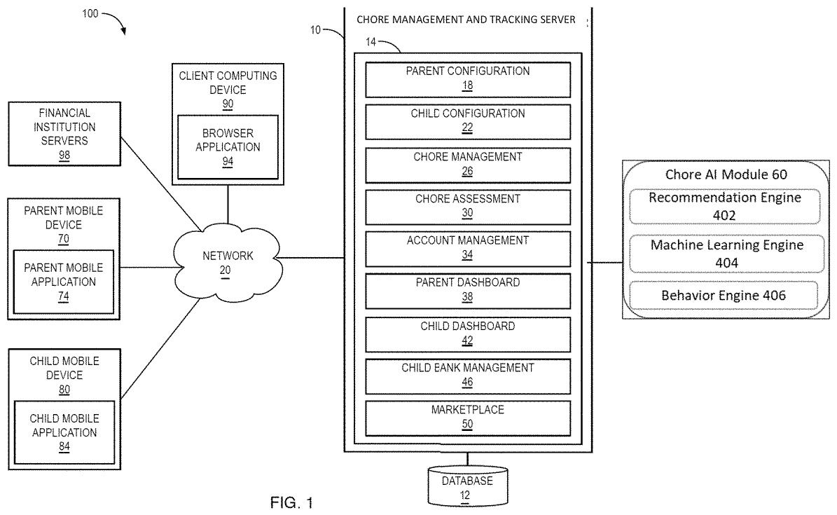

One embodiment of the system will now be described. According to various embodiments of the presently disclosed subject matter, a system such as system 100 as illustrated in FIG. 1 is provided for managing payment transactions associated with a task completion. FIG. 1 is a block diagram of a management and tracking system such as the s'mores management and tracking system (or “system”) 100 according to one embodiment of the present invention. The system 100 includes at least one chore management and tracking server such as server 10 operative to communicate with a plurality of user or client computing devices (e.g., mobile devices 70, 80 and client computing device 90). In one embodiment, server 10 is a web server. Server 10 is connected to the mobile devices 70, 80 and client computing device 90 by a network 20 (e.g., the Internet), which may be wired, wireless, or any combination thereof. The mobile devices 70, 80 and client computing device 90 are each operated by a user, such as a parent, guardian, minor, child, project organizer, and project participant, among others. The descriptions below will be discussed in a parent child setting for ease of understanding. In one embodiment, server 10 is a computing device.

By way of non-limiting examples, in FIG. 1, client computing device 90 may be a personal computing device (e.g., a mobile device) the mobile devices 70, 80 may be mobile devices belonging to a parent and a child, respectively. Mobile devices 70, 80 and client computing device 90 may be located remotely from the server 10. Mobile devices 70, 80 and client computing device 90 may include computer hardware and operating environment as found on generic client-side computing devices including mobile devices such as mobile phones, tables, laptops, desktops and the like.

Server 10 is configured with a web application 14 operative to provide a website to the mobile devices 70, 80 and client computing device 90. Server 10 is operative to provide a downloadable parent mobile application 74 for execution on the parent mobile device 70, and a child mobile application 84 for execution on the child mobile device 80. In one embodiment, parent mobile application 74 and child mobile application 84 form sub-parts of web application 14. The web application 14 and mobile applications 74 and 84 may provide similar functionality. The server 10 may include components operable to display the website on the mobile devices 70, 80 and on client computing device 90. For example, server 10 may be operative to cause a web page to be displayed on a display of the mobile devices 70, 80 and client computing device 90 when one of the computing devices requests a URL using a web browser application (e.g., a web browser application 94 of the client computing device 90). Server 10 is also coupled to database 12 that includes storage operative to store information such as user account/profile information, chores, payments, financial account access authorization information, and the like. Server 10 is also coupled to one or more financial institution servers 98 (e.g., servers operated by a bank), which allows the system 100 to transfer funds between internal system accounts as well as external accounts held at one or more external financial institutions. In various embodiments, server 10 is accordingly a server configured for managing payment transactions associated with a task completion. According to at least one embodiment, server 10 comprises a memory including a first database (e.g., database 12 of FIG. 1) configured to store information associated with a plurality of users, a digital coin ledger including records associated with a plurality of digital coins, and a second database (e.g., database 12 of FIG. 1) associated with a plurality of purchase items each having an assigned digital coin value. The first database can include records related to all members within a family, all members within a community, all members within a learning environment, and similar other information. As noted earlier, system 100 further includes chore AI module 60. Chore AI module 60 is explained in further detail earlier in this document with respect to FIG. 4.

While system 100 is illustrated as including a single server 10, system 100 may include any number of server computer devices that each perform the functions of the server 10 or cooperate with one another to perform those functions. Further, while the server 10 is illustrated as being connected to the mobile devices 70, 80 and client computing device 90, those of ordinary skill in the art will appreciate that the server computing device may be connected to any number of client computing devices and the server computing device is not limited to use with any particular number of client computing devices.

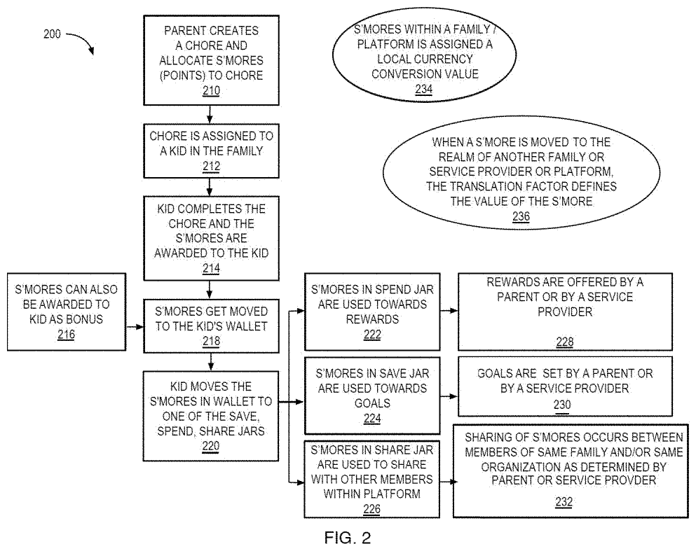

The web application 14 comprises a plurality of functional modules configured to implement the features of the system. Specifically, the web application 14 comprises a parent configuration module 18, a child configuration module 22, a chore management module 26, a chore assignment module 30, an account management module 34, a parent dashboard module 38, a child dashboard module 42, a child bank management module 46, and a marketplace module 50. Some or all of these modules may also be provided on the mobile device applications 74 and 84 that are executable on the parent mobile device 70 and child mobile device 80, respectively. Several of these functional modules, including the chore AI module 61, will described in further detail with reference to FIGS. 2-4.

FIG. 2 refers to digital coins as s'mores. As explained earlier, the rewards within the system can be in the form of digital coins such as, for example, s'mores (i.e., the term “s'mores” is a name assigned to the digital coins in at least one embodiment whereby children may better relate to the accumulation of digital coins). As illustrated in flowchart 200 of FIG. 2, in one exemplary process, at step 210, a parent creates a chore and allocates one or more s'mores (or points) to the chore; the parent can further assign the chore to a kid. At step 212, the chore is assigned to a kid in the family At step 214, the system 100, after receiving confirmation from the kid, can send a notification to the parent or other “approver” that a child has completed an assigned chore; further, system 100 can proceed to award the s'mores assigned to the chore to kid. The notification to the parent/approver can be in any suitable form, including email, text message, voice message, “push” notification, etc. The parent/ approver is then provided with an opportunity by system 100 to approve the completion of the chore. According to one example, the parent/approver may wish to first inspect the work before providing an approval. In the case when the kid's performance of the chore is unsatisfactory, the parent also has the opportunity “reject” the completion notification and provide feedback to the kid via message (e.g., email, text message, application notification, etc.). As an illustrative example, for the chore that comprises mowing a lawn, a parent/approver may respond to the kid's completion notification with the message “the edges have not been trimmed.” The kid may then be given another opportunity to complete the chore in a satisfactory manner This process may be repeated until the parent/approver is satisfied with the child's performance of the chore. Once the parent/approver has accepted or approved completion of the chore, s'mores corresponding to the value of the completed chore may be awarded and thereby approved for transfer at step 214. In one alternate embodiment, at step 216, the parent/approver may also award bonus s'mores to the kid. At step 218, the awarded s'mores units are transferred from one of the parent's accounts (e.g., the first digital wallet associated with the first user) to the kid's account or wallet (e.g., the second digital wallet associated with the second user). At step 220, the kid moves the s'mores in the kid's wallet to the save jar, the spend jar or the share jar. At step 222, the s'mores in the spend jar are used towards purchase of rewards. At step 228, the reward is offered by the parent or a service provider. In various embodiments, the service provider may be determined by or assigned by system 100.

At step 224, the s'mores in the save jar are used towards the attainment of a predetermined goal; in one embodiment, the goal may represent the collection of 100 s'mores, for example, and when the goal is ultimately reached, the 100 s'mores may subsequently exchangeable, for example, for a trip to an amusement park. At step 230, the goal is set by the parent or a service provider.

At step 226, the s'mores in the share jar can be used to share with one or more other members within the platform. In various embodiments, the other member can be a sibling of the kid, a cousin, a church member, a classmate, a community member, or a similar other member. At step 232, the s'mores may be shared between members of the same family and/or the same organization as determined by the parent or a service provider.

In various embodiments, at step 234, the s'mores within a platform or family is assigned a local currency conversion value. For example, the s'mores within a family setting may be assigned a value of ten s'mores equals one US dollar. In some embodiments, at step 236, when one or more s'mores is moved to another family or service provider or platform, the translation factor assigned at step 234 is used in step 236 for defining the local currency equivalent value of the s'mores being transferred.

In various embodiments, the digital coin ledger is an advantageous aspect of the present invention. In one embodiment, the digital coin ledger resides at server 10. In alternate embodiments, the digital coin ledger may reside at an external data storage device communicatively coupled to the processor of server 10 through the network 20. In one embodiment, the ledger may be distributed whereby the distributed digital coin ledger is held and updated independently by each participant (or node) in a large network; the records are not communicated to various nodes by a central authority, but are instead independently constructed and held by every node; that is, every single node on the network processes every transaction, coming to its own conclusions and then voting on those conclusions to make certain the majority agree with the conclusions. Once there is this consensus, the distributed ledger has been updated, and all nodes maintain their own identical copy of the ledger. This architecture may advantageously allow for dexterity as a system of record that goes beyond being a simple database. The digital coin ledger as referred to herein may conveniently apply to both static data (a registry), and dynamic data (transactions). The digital coin ledger may permit users to move beyond the simple custodianship of a database by providing for management of a system of record.

In one embodiment, the digital coins managed by server 10 use cryptography for security since a digital coin with cryptography security (alternately referred to as a “cryptocurrency”) is difficult to counterfeit because of this security feature. The cryptocurrency may be based on blockchain technology. In one embodiment, the digital coins managed by the server may be modeled after, and have specifications similar to that of, the Bitcoin cryptocurrency. In one embodiment, the digital coins may be assigned a trade name or service name “s'more” in singular and “s'mores” in plural. In various embodiments, the server uses blockchain technology to store an online ledger of all the transactions that have ever been conducted using s'mores (also referred to herein as the “digital coin ledger”) with every new block generated required to be verified by the ledgers of each user on the s'mores market, making it almost impossible to forge transaction histories. The s'mores market may be limited to a home environment or to a local community in some embodiments; in other embodiments, the s'mores may not have any such restrictions and thus could be trade-able across several environments as determined by the administrator of the system.

In several embodiments, the purchase items may represent one or more of goods and services provided by a vendor offering preferred market pricing. In various embodiments, the purchase items can include activities enjoyed by children such as: watching movie with mom; baking cake with mom; playing soccer with dad; playing a board game with mom and/ or dad; permission to hang out at friend's house; spending time at mom's or dad's office; and, similar other activities that do not necessarily involve expenditure of money but may be of value to the child, the minor or the project participant. In some embodiments, some of the items available for purchase may not have a monetary value assigned to the same. In some other embodiments, the items without monetary value may nonetheless be assigned a digital coin value or a s'mores value. For example, in one embodiment, a “smart child—level 1” certification may require digital coins in order for a child or kid to acquire it; however, the “smart child1'level 1” certification may not include a local currency value directly assigned to it.

Server 10 can further include a processor as well as instructions in the form of a computer program that is executable by the processor. In various embodiments, through the execution of computer program (for example, in the form of web application 14) by the processor, the processor is configured to receive a service assignment and a digital coin value associated with the service assignment over a network from a first computing device associated with a first user. The processor is also configured to send the service assignment over the network for display on a second computing device associated with a second user. The processor is further configured to receive notification from the second user that the assigned service has been completed. The processor is furthermore configured to transfer digital coins equal to the digital coin value of the service assignment from a first digital wallet associated with the first user to a second digital wallet associated with the second user. The processor is additionally configured to record the transfer of the one or more digital coins in the digital coin ledger. The processor is also configured to, in response to a prompt from one or more of the first user and the second user, apply the one or more digital coins in the second digital wallet to acquire one or more purchase items.

In various embodiments, system 100 or server 10 is further configured to convert the digital coins in the second digital wallet to an equivalent cash value based on a predetermined conversion rate. Server 10 is also configured to transfer the equivalent cash value from the first digital wallet to the second digital wallet. In various embodiments, the first digital wallet can be linked to an external financial institution server owned by an entity such as a bank or a credit union or a credit provider such as a credit card issuing company. System 100 or server 10 can be further configured to add funds to the first digital wallet from the external financial institution server. In other words, server 10 and /or system 100 is configured for automatic transfer of funds from a bank to the first digital wallet and vice versa. In some embodiments, server 10 and /or system 100 is configured for automatic transfer of funds from a bank to the second digital wallet and vice versa. In various embodiments, server 10 and /or system 100 can be further configured to receive an approval notification from the first user prior to transferring the one or more digital coins to the second digital wallet. As noted earlier, the digital coin ledger resides on an external data storage device communicatively coupled to the processor of server 10.

In various embodiments, the first user can be a parent, caretaker, guardian, teacher or project owner/organizer/leader or a similar other individual, and the second user can be a child, a student, a project worker/member or a similar other individual. For example, in one embodiment, the second user is a child and the first user is a parent of the child. In another embodiment, the second user is a project member and the first user is a project organizer.

In various embodiments, server 10 is configured to communicate with an application executing on one or more of the first computing device such as parent mobile device 70, and the second computing device such as child mobile device 80. For example, the application can include a component such as parent mobile application 74 executing on the first computing device such as parent mobile device 70, and a component such as child mobile application 84 executing on the second computing device such as child mobile device 80. Server 10 and/or system 100 is further configured to display on a graphical user display of the second computing device, links to the plurality of purchase items. In some embodiments, the mobile application can further be accessed via a browser application such as browser application 94 executing on the client computing device such as client computing device 90.

In various embodiments, server 10 is configured to maintain a history of subsequent transactions associated with the one or more digital coins in the digital coin ledger. In some embodiments, server 10 is further configured to transfer the one or more digital coins to another server operating outside the closed environment. In some embodiments, server 10 is further configured to transfer the equivalent cash value to a further server operating outside the closed environment.

In various embodiments the server is also configured to apply near field communication (NFC) technology to allow the second user to pay for the acquired purchase items. This way, the second user (or the first user) can advantageously pay for an item at a store via the mobile application forming part of system 100 using the NFC technology.

In some embodiments, the s'mores may take the form of a non-fungible token (NFT). As is well-known in the relevant art, a NFT is a unit of data stored on a digital ledger, called a blockchain, that certifies a digital asset to be unique and therefore not interchangeable. NFTs can be used to represent items such as photos, videos, audio, and other types of digital files. Access to any copy of the original file, however, is not restricted to the buyer of the NFT. While copies of these digital items are available for anyone to obtain, NFTs are tracked on blockchains to provide the owner with a proof of ownership that is separate from copyright. The system may further include features within the s'mores in the form of NFTs to ensure that the digital item represented is authentically one-of-a-kind. In one embodiment, the s'mores in the form of NFTs may form part of the Ethereum blockchain.

In various embodiments, the system accordingly provides for a server for managing payment transactions associated with task completion within a closed environment. The server includes a memory containing a database configured to store information associated with a plurality of users, a digital coin ledger with records associated with a plurality of digital coins, and a list associated with a plurality of purchase items each having an assigned digital coin value. The system further includes a processor configured to receive an assignment of a service and an associated digital coin value by a first user to a second user via a first client computing device operated by the first user over a network. In one embodiment, the assignment represents a household chore assigned by a parent to a child. In another embodiment, the assignment is a task assigned by a project leader or manager or organizer to a project participant. The processor sends the assigned service to the second user (e.g., a child) over the network for display on a second client computing device operated by the second user. The processor further transfers digital coins equal to the digital coin value of the assigned service from a first digital wallet associated with the first user to a second digital wallet associated with the second user after receipt of notification from the second user indicating the assigned service has been completed.

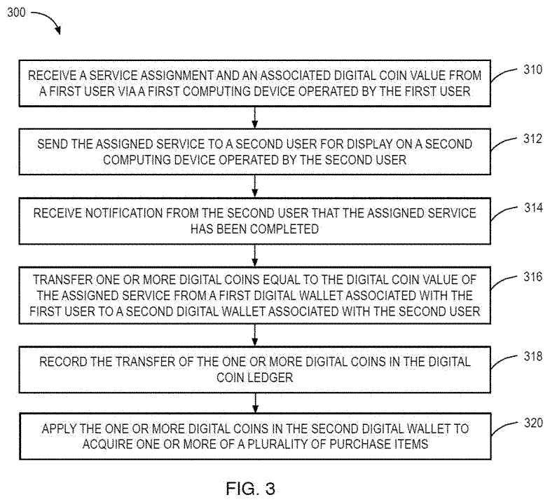

One method of managing payment transactions associated with task completion within a closed environment is illustrated in flowchart 300 of FIG. 3. As illustrated in FIG. 3, the method includes receiving a service assignment and an associated digital coin value from a first user via a first computing device operated by the first user, at step 310. The method further includes sending the assigned service to a second user for display on a second computing device operated by the second user at step 312. The method also includes receiving notification from the second user that the assigned service has been completed at step 314. The method furthermore includes transferring transfer one or more digital coins equal to the digital coin value of the assigned service from a first digital wallet associated with the first user to a second digital wallet associated with the second user at step 316. The method additionally includes recording the transfer of the one or more digital coins in the digital coin ledger at step 318. The method also includes applying the one or more digital coins in the second digital wallet to acquire one or more of a plurality of purchase items at step 320.

Advantageously, the processor forming part of the server or the digital ledger operates to record the transfer in the digital coin ledger. The digital ledger maintains a continuous and ongoing record associated with each digital coin issued by the system, until instructed otherwise by the system's rules as set by the administrator of system 100. In response to a prompt from the second user, the processor applies the one or more digital coins in the digital wallet associated with the second user to acquire one or more purchase items. The purchase items need not necessarily have a cash value associated with them. For example, a movie night with mom may be one of the items available for purchase. The purchase items may represent any item that may have a perceived value from the perspective of a child, a minor, or a project participant. In some embodiments, the server or system waits for receipt of an approval notification from the first user prior to transferring the one or more digital coins to the second digital wallet associated with the second user.

In some embodiments, the server is further configured to convert the digital coins in the second digital wallet to an equivalent cash value based on a predetermined conversion rate. For example, in one embodiment, the server allows the first user to assign a conversion rate for converting the s'mores digital coins to an equivalent currency value. As an illustrative example, the first user may assign a conversion rate of 100 s'mores digital coins to a US dollar; in some embodiments, each family may assign its own arbitrary conversion rate from the s'mores digital coins to a US dollar. In some embodiments, the server is also configured to transfer the equivalent cash value from the first digital wallet either to the second digital wallet or to a central repository. This way the first user will understand that the underlying cash has been effectively expended. In various embodiments, the first digital wallet is linked to an external financial institution server. The external financial institution may represent a bank, a credit union, or a credit card provider in various embodiments. The server is further configured to add funds to the first digital wallet from the external financial institution server. For example, as set up by the first user, the server may periodically transfer a predetermined amount of money from an account associated with the first user from the external financial institution to the first digital wallet associated with the first user.

In various embodiments, the server is capable of communicating with a mobile application executing on a mobile client computing device such as parent mobile device 70 and child mobile device 80. The server is additionally capable of displaying on a graphical user (GUI) display of the mobile client computing device, links to the plurality of purchase items. The plurality of purchase items may be directly stored at the server in some embodiments. In other embodiments, the server may only maintain links to a plurality of items which are stored at another online location. The mobile application operating on the mobile device may display on the GUI of the mobile device various aspects associated with the system. In one embodiment, the mobile application allows for touch-based interaction with the server and the system. In the same or a different embodiment, the application allows for voice-based interaction with the server and the system.

In some embodiments, a predetermined conversion rate is set by the first user. In various embodiments, the server permits the first user to assign restrictions on how the s'mores digital coins are expended. For example, a parent may prohibit a child from using the digital coins to purchase tobacco products. In some embodiments, the restriction is associated with a maximum expendable amount over a predetermined time period. For example, a parent may allow a maximum of ten US dollars to be expended during a 30-day period. In another example, the restriction may be associated with a spend rate per unit of time at which the one or more digital coins can be expended. For example, the first user may stipulate that a maximum of 100 US dollars can be spent within each quarter of a year. In some embodiments, the restriction is associated with a specified period of time before which the digital coins cannot be expended. For example, a parent may allow an allowed digital coin amount to be expended after a 30-day waiting period in order to teach delaying of gratification to a child. In a further example, the restriction may be associated with a predetermined list of organizations or individuals or entities to which the one or more digital coins can be transferred to; for example, the s'mores digital coins may be restricted for used with for purchase of only healthy food items as determined by the parent, guardian or project organizer. In another example, the s'mores digital coins may only be expended for purchase of school supplies. In another example, the s'mores digital coins may only be donated to one or more predetermined charities. In another example, the first user may provide a second user a specified subset of the plurality of purchase items on which the earned s'mores digital coins can be expended by that second user. In some embodiments, the purchase items include one or more of goods and services provided by a vendor offering preferred market pricing. In various embodiments, after the first transfer of digital coins from the first user to the second user, the server maintains a history of subsequent transactions associated with the one or more digital coins in the digital coin ledger.

In one embodiment, the server is further configured to transfer the s'mores digital coins (or “s'mores” in short) accumulated by the second user to another server operating outside of the closed environment where the s'mores were generated; the s'mores may be converted to an equivalent local currency (e.g., US dollars) prior to the transfer to the other server. In one embodiment, the other server may represent an internet marketplace such as, for example, Amazon, eBay, or a similar other online marketplace. In one embodiment, the server is further configured to facilitate purchase of good and services provided by vendors unrelated to the closed environment using the equivalent cash value. In one embodiment, the vendors unrelated to the closed environment may not recognize the s'mores and accordingly the equivalent cash value may be used for the completion of purchase transactions.

In some embodiments, several vendors may be recruited to be part of the s'mores environment whereby the recruited vendors may recognize the s'mores as alternatives of the underlying cash value assigned to them by a responsible party operating within the s'mores system. In one embodiment, the server is configured to use near field communication (NFC) technology to allow the second user to pay for the acquired purchase item.

The s'mores digital coins as described herein may be used in conjunction with a parenting platform or system with a trade name or service name “S'moresUp” designed to help modern-day parents tackle parenting challenges. In one embodiment “S'moresUp” can include components such as web application 14, parent mobile application 74, child mobile application 84, and one or more components of payment management and tracking server 10 listed in FIG. 1. S'moresUp as an online platform system may permit digitized control over allowances provided to children. S'moresUp may thus provide a simple and easy chore management system that manages all aspect of the chore-reward system. The list of chores may be created and managed by parents. The created chores may be assigned to anyone within a family In one embodiment, each chore may possess the following attributes: name of the chore; points (i.e., s'mores) assigned to the chore; frequency at which the chore needs to be completed (e.g., daily, weekly, monthly, or one-time occurrence, as application) and the name of the person /child that the chore is being is assigned to.

S'mores collected within the S'moresUp platform or S'moresUp system may accrue in the digital wallet associated with each child. Completing a chore is just one way to earn s'mores. Another way a child may earn s'mores is when a parent awards some bonus s'mores, for example. S'mores collected may be traded in for small ticket items or for big ticket items. The rewards and goals (i.e., the purchase items) may represent material things that have an inherent value associated with them (e.g., pizza or toys) or an activity within the family (e.g., movie night with mom).

Each family may assign an arbitrary s'mores to US dollar conversion value, for example The conversion rate may differ from family to family The conversion value is advantageous when a s'more is moved outside of a family's network or when the s'more exchanged from real money. S'mores may be spent on rewards assigned by parents; a s'more may be shared with members of the same family or in another family; a s'more may also be shared with other organizations registered within the platform, system or server. A s'more may be divided into subunits in some embodiments. A s'more may also be shared between families

The server may maintain information regarding how a particular s'more got into the system and all the transactions that the particular s'more was associated with. A s'more created in the system is unique and may be traced back to the creator. A s'more may have restrictions associated with it as to where it can be expended (e.g., a specific service or merchant or a group or a category). In one embodiment, a s'more may also have restrictions associated with such that it can only be used within a realm of a group of families or a selected geographical location. In various embodiments, a s'more is backed by real money (e.g., backed by a local currency such as the US dollar) when it is moved between realms such that when a s'more crosses from one realm to another, real money is moved between realms. In some embodiments, a s'more may include an identifier such as a family name indicative of the family that requested generation of that s'more. The s'more may also be designed and personalized to possess unique attributes as it travels in the virtual space. The flow chart below indicates one embodiment associated with the implementation of the invention as described herein.

In some embodiments, a new set of unique s'mores may be issued to commemorate a birthday, an anniversary, or a similar other event or occurrence referred to herein as “commemoration s'mores”. Commemoration s'mores may be issued to folks outside a family circle. In one example, all attendees to a birthday party may receive one or more commemoration s'mores associated with the event. The recipients of the commemoration s'mores may be assigned a closed community group by the server or the system whereby the commemoration s'mores can be traded or otherwise expended for purchase articles available within the S'moresUp closed community platform, and optionally outside of the S'moresUp closed community platform.

In another embodiment, the s'mores issued within one family environment may be labeled based on the family's name. This has the effect of creating digital coins customized for a particular family, in effect creating a family digital currency. This may advantageously allow all members within an extended family to possess, exchange, and otherwise use a digital coin customized for use just by that family Such customized family digital coins would be allocated a conversion rate for converting into a local currency such as the US dollar.

Children may earn money in a variety of manners. For example, some parents may provide a child with an allowance under a pre-determined schedule (i.e., weekly, monthly, etc.). Some parents may provide an allowance based on whether or not a child completes their assigned chores. Children may also earn s'mores by performing special projects from time-to-time, or as gifts (birthdays, special events, holidays etc.) from family members and friends. The s'mores tracking feature may be configured to tag sources and uses of s'mores so that the child and the parent are able to clearly track where their money has come from and where it goes.

A parental control module that forms part of parent mobile application 74 may enable a parent to have oversight over their children's accounts. The parent control module may be configured to enable a parent to create accounts for their children, decide how their children's s'mores should be allocated to each of the children's sub-accounts as applicable, and to review, authorize and administer children's spending, sharing, and savings.

A child account management module that forms part of child mobile application 84 provides tools which enable a child to exercise some control over their account. For example, the child account management module provides an interface which enables a child to view their funds in the form of s'mores, make purchases, make saving and investment decisions, and/or choose charities for making s'mores donations to. Some or all of these activities may require parental approval. The child account management module may also provide an interface which enables the child to view a schedule of when, how much, from whom and in what way, s'mores (and consequently real money) can be earned.

A spending module that forms part of child mobile application 84 may be provided to present an interface to one or more trusted on-line vendors. In some embodiments, the online vendors allow children to purchase gift cards. In other embodiments, the vendors provide full e-commerce functionality through the money management system or platform. In some embodiments, children may be able to make purchases from vendors other than the online vendors using the s'mores. In some embodiments, the spending module is further configured to facilitate purchase of one or more of goods and service provided by a vendor not listed within using the equivalent cash value. In some embodiments, spending module is provided with a predetermined list of organizations or individuals to which the digital coins can be transferred to. In some embodiments, the system can include a restriction associated with a specified subset of the plurality of purchase items on which the digital coins can be expended. In some embodiments, the system can include a restriction associated with a rate at which the one or more digital coins can be expended.

A sharing module that forms part of child mobile application 84 may provide an interface for making donations to one or more charitable partners. The sharing module may also enable children to collectively pool their sharing account funds or establish, lead and/or join a particular cause of interest which other members may donate to.

A savings module that forms part of child mobile application 84 may be provided to enable a child to explore savings and investment options. For example, the savings module may be configured to provide options for how money (associated with the accrued s'mores) is best saved and invested. This may include, presenting different saving account options with differing terms and interest rates for example, savings accounts, money market funds, certificates of deposits, and/or other investment opportunities. In some embodiments, the savings module will invest real money associated with the accrued s'mores, through decisions directed by the child, and approved by the parent following all applicable laws and regulations.

Child accounts that form part of child mobile application 84 may be partitioned into a savings account, a spending account, and a sharing account. Savings accounts encourage online saving and safe investing. Share accounts allow children to direct money allocated by the parent and/or child for sharing to be donated to charities of the child's choice. Spend accounts provide a private and secure channel for kids to conduct smart online commerce. Parents may establish allocation levels for each of their child's three accounts. For example, assuming allocations of 80% saving, 5% sharing, and 15% spending would suggest that for every $10 a child earns, $8 will be allocated to savings, $0.5 to sharing, and $1.5 to spending According to some embodiments, a child may suggest an allocation, and the parent can then approve or disapprove of the allocation. Additionally, parents and children can agree on what percentage of the child's earned money (corresponding to the earned s'mores) will be allocated to their sharing account. While the parent retains complete control over all settings (e.g., allocations, amounts, purchases, etc.), the child feels empowered by initiating spending, saving and sharing decisions, learning from visual and descriptive information flows, and by being an active member of the decision process.

The systems and methods of the present application provide for online money management, wherein children learn money management skills and cultivate their social conscience. These systems and methods provide a convenient, easy, safe, and controlled environment that teaches financial responsibility, while imparting family values in a child through financial decision-making and tangible giving. Children are experientially empowered to manage “their” money, making it real, visual, and fun. Children are provided with opportunities to earn money from family and friends in many ways, including a traditional allowance, an allowance received in exchange for completed chores, through the completion of special projects and/or tasks, from the receipt of gifts and in other ways. Earned money is then allocated by the parent/guardian or child and deposited as s'mores to a child's save, spend, and share accounts. The digital wallets allow for real-time consumption of products or services while teaching the importance of smart spending and delayed gratification. The digital wallets also allow kids to make tangible donations with their own money toward causes of interest most important to them. The ability to track the history of all transactions associated with each assigned s'more provides comfort to parents knowing that they have complete control of their children's online financial and social experience. The systems and methods described herein thus provide a financially transparent model which engenders trust, promotes financial education, and provides sound saving and spending opportunities through the advantageous use of s'mores digital coins.

According to one aspect of the invention, the S'moresUp platform may include a social media feature to facilitate communication between and among families that provides a network for parents to connect with other parents through the platform/network. In one embodiment, a parent may be able to view those posts from fellow parents that are tagged either as “community” (whereby the post is viewable by every parent on the S'moresUp platform) or as “friends & family” (whereby the post is viewable only to those parents that are connected to the family that posted the content). By default, both “community” posts as well as the “friends and family” posts are not viewable from a child account irrespective of whether the child belongs to the “connected” family However, the S'moresUp platform may permit a parent that is able to view the post to share such a “parent only” post with one or more children within that parent's family by clicking on the action “share” and then forwarding/sharing the post with one or more children in the family such that the selected children can view the post when they sign in to the S'moresUp platform from their individual child accounts. This feature may advantageously create a firewall for children with accounts in S'moresUp platform whereby the parent of each child in the platform may act as a gatekeeper to determine whether to pass on information shared at the “parents” account level to a child's account as appropriate.

According to another advantageous feature, when a child posts something from the child's account, such post may only be viewable by members within the same family as the child, but not by any other members within the S'moresUp platform including members of a family that is connected to the family to which the child is a member of. However, the S'moresUp platform may permit a parent to share such a “family only” post at different audience levels as determined by the parent—with other connected parents, with other connected families (this would include children accounts within the connected families), or with everyone having an account on the S'moresUp platform. The parent may accomplish this by clicking on the action “share” and then forwarding/sharing the post with the selected audience. This feature too creates a firewall for protecting children with the respective parent acting as a gatekeeper to determine whether to pass on information shared within the family to a larger audience within the S'moresUp environment. In one embodiment, the parent may be able to control which individuals the children within the family can connect to. For example, a child in a first family may be able to connect to another individual in a second family within the S'moresUp platform only after a parent in the first family authorizes such a connection. The size of S'moresUp platform as described herein may represent any number of members as determined by the administrator or by any responsible party authorized by the administrator.

In some embodiments, the system can seamlessly integrate with other smart devices including smart appliances such as, for example, laptop computers, desktop computers, tablets, television sets, refrigerators, washing machines and dryers, dishwashers, ovens including microwave ovens, and smart cars, among others, in order to manage and track completion of chores, and to facilitate rewarding of appropriate folks when such chores are completed to satisfaction.

In some embodiments, they system can seamlessly integrate with a financial institution such as a bank issuing credit/debit cards through which a child may be able to spend the earned s'mores points for making contributions to worthy projects by making payments using the credit/debit card, wherein the credit/debit card accrues the local currency value equal to the s'mores points earned by a given child based on the assigned conversion rate. The system can additionally allow for the integration of a wish list service (such as, for example, the wish list service provided by Amazon, eBay and similar other service providers) into the s'mores reward system such that such outside wish list items may be listed in the rewards list for a child or individual to redeem through the system as described herein.

In various embodiments, the system also provides for the ability of a child to trade-in the earned s'mores to “buy” screen-time through the system. For example, when a s'mores reward is claimed and approved by a parent or adult, the system can operate to permit a device associated with the child to get automatically unlocked and stay unlocked for pre-determined time period in order for the child to use the device to view and/or interact with various content such as, for e.g., YouTube videos, social media applications, video games, and similar other content.

In some embodiments, the system can require an approval of a parent or adult before a number of s'mores that has previously been awarded to a child can be made available for use by the child, even though the child has technically already “earned” those s'mores. According to at least one embodiment, a chore is set up by a parent or adult and the s'mores assigned for the chore is transferred to a child's account after a parent or adult approves the completion of a chore. The parent or adult can optionally require a photograph proof illustrating the completed chore; the s'mores assigned for the chore get transferred to the child's account only after the parent or adult is satisfied with the photograph The system can further require that the s'mores reward claimed by a child is approved by a parent or adult for spending before the child can actually spend the s'mores reward.

In some embodiments, the system is configured to charge a penalty against the number of s'mores assigned to a chore if the chore is not completed within the assigned time frame. In some embodiments, the penalty for being late may be a percentage of the number of s'mores assigned to the chore, and the system may move the penalty s'mores amount to an assigned digital jar controlled by the system. The settings for items such as the penalty s'mores percentage, the digital jar assigned to collect the penalty s'mores, and similar other items can be adjusted through a user interface available within the system.

The system can be further configured to integrate with a cloud based digital home management environment such as, for example, Amazon's Alexa, Google's Home, Microsoft's Cortana, Apple's Siri, and similar other environments and applications. The application associated with the system as described herein can be added as a skillset in one or more of such ecosystems and downloaded onto the cloud based digital home management environment whereby the system can integrates with, and operate seamlessly within, such ecosystems.

Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer and the like which are within the scope of the disclosure.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance - including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running People and/or organizations buy or lease storage capacity from the providers to store user, organization, or application data. Cloud storage services may be accessed through a co-located cloud computing service, a web service API, or by applications that utilize the API.

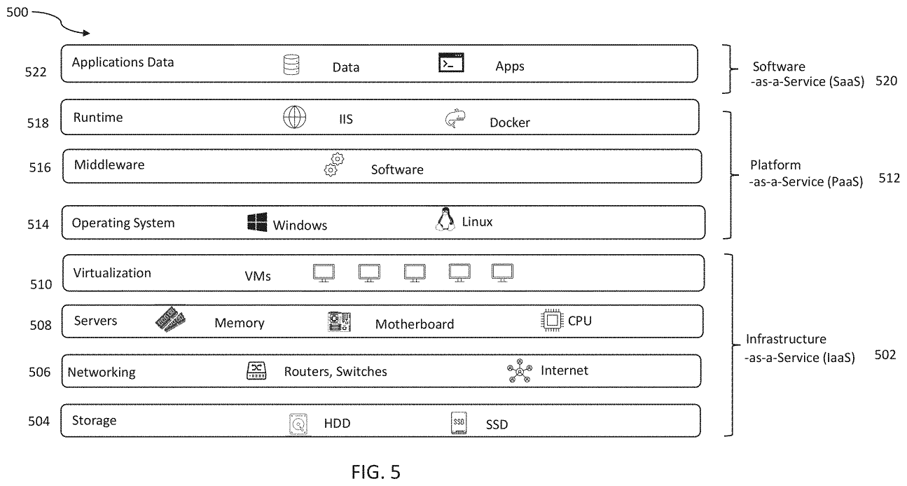

FIG. 5 is an illustration of an exemplary software-as-a-service (SaaS) model. Referring to FIG. 5, functionality 500 can be logically divided into layers. Layers may be ordered from least to greatest abstraction of underlying physical resources. Layers may also be divided into groups based on common features for simplicity when referring or billing functions associated with each group.

Infrastructure 502 includes storage function 504, networking function 506, server function 508, and virtualization function 510. Infrastructure functions 504-510 may be bundled together and provided to one or more tenants as a service, referred to as Infrastructure-as-a-Service (IaaS). IaaS is made up of a collection of physical and virtualized resources that provide consumers with the basic building blocks needed to run applications and workloads in the cloud.

Storage function 504 provides storage of data without requiring the user or tenant to be aware of how this data storage is managed. Three types of cloud storage that may be provided by storage function 504 are block storage, file storage, and object storage. Object storage is the most common mode of storage in the cloud because that it is highly distributed (and thus resilient), data can be accessed easily over HTTP, and performance scales linearly as the storage grows.

Networking function 506 in the cloud is a form of software defined networking in which traditional networking hardware, such as routers and switches, are made available programmatically, typically through APIs.

Server function 508 refers to various physical hardware resources associated with executing computer-readable code that is not otherwise part of the virtualized network resources in networking function 506 or storage function 504. IaaS providers manage large data centers, typically around the world, that contain the servers powering the various layers of abstraction on top of them and that are made available to end users. In most IaaS models, end users do not interact directly with the physical infrastructure (e.g., memory, motherboard, CPU), but it is provided as a service to them.

Virtualization function 510 provides virtualization of underlying resources via one or more virtual machines (VMs). Virtualization relies on software to simulate hardware functionality and create a virtual computer system. A virtual computer system is known as a “virtual machine” (VM): a tightly isolated software container with an operating system and application inside. Each self-contained VM is completely independent. Putting multiple VMs on a single computer enables several operating systems and applications to run on just one physical server, or “host.” A thin layer of software called a “hypervisor” decouples the virtual machines from the host and dynamically allocates computing resources to each virtual machine as needed. Providers manage hypervisors and end users can then programmatically provision virtual “instances” with desired amounts of compute and memory (and sometimes storage). Most providers offer both CPUs and GPUs for different types of workloads.

Platform 512 includes operating system function 514, middleware function 516, and runtime function 518. Infrastructure functions 504-510 and platform functions 514-518 may be bundled together and provided to one or more tenants as a service, referred to as Platform-as-a-Service (PaaS). In the Platform-as-a-Service (PaaS) model, developers rent everything needed to build an application, relying on a cloud provider for development tools, infrastructure, and operating systems.

Operating system function 514 refers to a PaaS vendor providing and maintaining the operating system that developers use, and the application runs on. For example, Windows and LinuS operating systems may be installed in virtual machines and Windows or LinuS applications may be run within the operating system.

Middleware function 516 is software that sits in between user-facing applications and the machine's operating system. For example, middleware may allow software to access input from the keyboard and mouse. Middleware is necessary for running an application, but end users don't interact with it. Relatedly, middleware function 516 may also include tools that are necessary for software development, such as a source code editor, a debugger, and a compiler. These tools may be offered together as a framework.

Runtime function 518 is software code that implements portions of a programming language's execution model. A runtime system or runtime environment implements portions of an execution model. Most programming languages have some form of runtime system that provides an environment in which programs run. This environment may address issues including the management of application memory, how the program accesses variables, mechanisms for passing parameters between procedures, interfacing with the operating system, and otherwise. The compiler makes assumptions depending on the specific runtime system to generate correct code. Typically, the runtime system will have some responsibility for setting up and managing the stack and heap, and may include features such as garbage collection, threads or other dynamic features built into the language.

Software 520 includes applications and data function 522. Infrastructure functions 504-510, platform functions 514-518, and software function 522 may be bundled together and provided to one or more tenants as a service, referred to as Software-as-a-Service (SaaS). Applications and data function 522 is the application and associated data created and managed by the user. For example, an application programmed by the user for provided certain functionality disclosed herein may be exposed to the end user via a front end interface such as a web browser or dedicated front end client application. Neither the front end user nor the back end developer is required to manage or maintain services provided by platform 512 and infrastructure 502. This contrasts with on-site hosting of the same functionality.

In some embodiments, the system can further include enhanced features suited for special need individuals including individuals with autism, individuals with attention deficit hyperactivity disorder (ADHD). In some embodiments, the system can further include enhanced features suited for individuals recovering from substance abuse and for individuals in recovery houses or otherwise in recovery programs. The system can advantageously help various individuals in maintaining a schedule for their chores/tasks.

In various embodiments, system 100 can include additional features such as:
a. Ability to render a chore or group OF chores Inactive or suspended.
b. Ability to add a category to blog posts appearing within a community
c. Ability to take away the awarded s'mores for misbehavior, for example
d. Ability to provide advanced chore types such as compete, Collaborate, anytime, optional and rotate
e. Ability for all devices within the family to get a notification when a comment is added to a post on a family wall
f. Ability to perform analytics for each platform or each family
g. Ability to rate the mobile application
h. Ability to add a comment to the posts
i. A separate kid's dashboard
j. Ability to pick a picture from S'mores gallery for customization purposes
k. Ability to associate wish list available on a web-based service provider such as, for example, Amazon to the rewards section of the application
l. Ability to automatically allocate between the spend, save, give buckets/jars
m. Ability to have awards, bonus, rewards & takeaway tiles to be visible only to parents and the child that has been awarded the same
n. Ability to add calendar event notifications for chores
o. Ability to view the chore report from parent's webpage and child's webpage
p. Ability to select optional due date while creating/editing a recurring chore
q. Ability to provide for a chore lock such that when a kid picks up an unassigned chore, that chore is locked out for other kids
r. Ability for a notification to be triggered to all devices within the family when a family post is posted by a member of the family
s. Ability for a notification to be triggered when a chore is assigned to a person

The systems and methods described herein may be implemented using commercially available devices, such as, for example cellular phones (e.g., Apple iPhone, Android devices) and network-enabled devices (e.g., desktop computer, laptop computer, tablets, netbooks, 2-in-1 computers, etc.).

It will be appreciated that the systems and methods described herein may be implemented using various types of user interfaces, such as user interfaces that allow the users to log in and update their profile, availability, etc. For example, as explained above, the user interface may be implemented in a mobile app, or on a web browser.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Rodin®, (Wand®, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A server for recommending chores for completion for a user of an electronic device, the server comprising:
a memory including a database configured to store information associated with a plurality of users, a digital coin ledger including records associated with a plurality of digital coins, and a second database associated with a plurality of purchase items each having an assigned digital coin value; and
an application coupled to a processor, the application configured to:
store a set of chores associated with a plurality of existing users in a plurality of network-based non-transitory storage devices, wherein each chore of the set of chores is assigned an existing user attribute score based on an existing user characteristic;
receive a first request by a first user in real time made through a graphical user interface over a network for registering with the application, the first request including a first user characteristic;
calculate a first user attribute score for the first request based on the first user characteristic;
compare the first user attribute score against a plurality of existing user attribute scores to identify a first chore from the set of chores such that an existing user attribute score of the first chore correlates to the first user attribute score; and
automatically generating a message containing the first chore send a signal in real time to an electronic device associated with the first user for display on the graphical user interface so that that the first user has immediate access to the first chore;
receive a notification that the first chore has been completed and a digital coin value associated with completion of the first chore;
transfer digital coins equal to a digital coin value from a first digital wallet associated with the first user to a second digital wallet associated with a member associated with the first user;
record the transfer of the digital coins in the digital coin ledger; and
in response to a prompt from one or more of the first user and the member associated with the first user, apply one or more digital coins in the second digital wallet to acquire one or more of the plurality of purchase items.

2. The server of claim 1, wherein the server is further configured to capture at least one of: a customization attribute made by the first user to the first chore, and a behavior attribute associated with completion of the first chore.

3. The server of claim 2, wherein the server is further configured to store the customization attribute to the database.

4. The server of claim 2, wherein the server is further configured to store the behavior attribute to the database.

5. The server of claim 3, wherein the server is further configured to receive a second request by a second user for registering with the application, wherein the server assigns a second chore for the second user based on a second user characteristics.

6. The server of claim 5, wherein the server is further configured to modify the first chore by at least one of the customization attribute and the behavior attribute to arrive at the second chore.

7. The server of claim 6, wherein the server is further configured to append the second chore to the set of chores.

8. The server of claim 2, wherein the server is further configured to store the customization attribute as a further user characteristic associated with the first chore.

9. The server of claim 2, wherein the server is further configured to store the behavior attribute as a further user characteristic associated with the first chore.

10. The server of claim 2, wherein the first chore is identified based one or more of: a number of family members associated with the first user, an age of a family member associated with the first user, a number of children associated with the first user that are under 18 years of age, and a location associated with the first user.

11. The server of claim 2, wherein the customization attribute comprises an adjustment made by the user to one or more of following suggestions supplied by the server: a chore reminder frequency, a chore repetition frequency, a chore reward magnitude, and a chore characteristic adjustment.

12. The server of claim 2, wherein the behavior attribute comprises a one or more of: a time take for completion of the first chore, number of reminders generated for the first chore, and a time interval taken beyond a deadline generated by the server for completion of the first chore.

13. The server of claim 2, wherein the server is further configured to capture a rejection of the first chore by the first user.

14. The server of claim 13, wherein the server is further configured to receive a second request by a second user for registering with the application, wherein the server assigns a second chore for the second user based on a second user characteristics, wherein the second chore is unrelated to the first chore.

15. The server of claim 1, wherein the first user characteristic comprises demographic information on family members associated with the user.

16. The server of claim 1, wherein the server is further configured to generate a ranked predicted list of chores for each request, the ranked predicted list of chores comprising at least some chores selected from a set of potentially recommendable chores, such that each particular chore within the ranked predicted list of chores has an associated rank.

17. The server of claim 16, wherein the server is further configured to assign a plurality of chores for the first user, wherein the plurality of chores is ranked based on the user characteristic.

18. The server of claim 17, wherein the server is further configured to receive notification from a family member associated with the first user that the assigned chore has been completed;
and transfer digital coins equal to a digital coin value of the assigned chore from a first digital wallet associated with the first user to a second digital wallet associated with the family member.

19. The server of claim 18, wherein the server is further configured to record the transfer of the digital coins in a digital coin ledger.

20. The server of claim 19, wherein the server is further configured to apply the one or more digital coins in the second digital wallet to acquire one or more of a plurality of purchase items.
